(19) United States
(12) Patent Application Publication
(10) Pub. No.: US 2008/0117906 A1
(43) Pub. Date: May 22, 2008

(54) PAYLOAD HEADER COMPRESSION IN AN RTP SESSION

(75) Inventor: Qiaobing Xie, South Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/561,679

(22) Filed: Nov. 20, 2006

(51) Int. Cl. H04L 12/56

(52) U.S. Cl. 370/392; 370/477

(57) ABSTRACT

An RTP payload header (408) is compressed by utilizing a codebook (514) that holds one or more indexable payload header variations and sending it to a receiving device (504). An RTP packet (400) that includes the payload header (408) with information pertaining to the packet is generated by a sending device (502) and the codebook is searched for the payload header information. If the information is found, the payload header (408) is replaced with a short index in the codebook (514). At the receiving device (504) the index is used to retrieve a payload header variation that corresponds to the index and the variation is placed back into the payload header (408) to uncompress the header.

### FIELD OF THE INVENTION

This invention relates in general to the field of communication, and more specifically to a system, method, and apparatus for compressing Real-Time Transport Protocol (RTP) packet payload headers.

### BACKGROUND OF THE INVENTION

Since electronic communication first began, there has always existed a desire to send more data along a given network in a shorter amount of time. Many schemes have been developed to accomplish this objective. One such scheme is to segment information into packets, compress one or more of the packets, and then send the packets to the designated receiver. The Real-time Transport Protocol (or RTP) defines a standardized packet format for delivering audio and video over the Internet.

Real-time multimedia applications over IP (e.g., VoIP) use RTP over User Datagram Protocol (UDP) as their transport protocol. A codec is a device or program capable of performing encoding and decoding on a digital data stream or signal. However, the codec must be given information about the format of the encoded data before it can decode the data. This is particularly true for variable rate codecs (e.g., AMR, EVRC). Therefore, before the data payload (e.g., voice frames, video frames) is sent over the RTP layer, an RTP media payload header specifically defined to enable the particular media codec to decode the payload is added. This payload header will appear in each RTP packet and hence contribute to the overall overhead for sending the multimedia data over IP.

There are well known techniques, such as Robust Header Compress (RoHC), developed to compress the RTP/UDP/IP headers. However, there is no method to effectively compress the aforementioned media payload header. Therefore a need exists to overcome the problems with the prior art as discussed above.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a diagram illustrating an exemplary communication network.

FIG. 2 is a block diagram illustrating a packet network switch.

FIG. 3 is an operational flow diagram of a header creation method.

FIG. 4 illustrates an RTP packet containing multiple media frames.

FIG. 5 is a schematic diagram illustrating communicatively coupled RTP sender and receiver according to an embodiment of the present invention.

FIG. 6 is an operational flow diagram of a header compression method at the sending device according to an embodiment of the present invention.

FIG. 7 is an operational flow diagram of a header compression method at the receiver device according to an embodiment of the present invention.

FIG. 8 is an operational flow diagram of payload header codebook updating according to an embodiment of the present invention.

### DETAILED DESCRIPTION

Embodiments of the present invention provide a method and a system for compressing a payload header in a Real-Time Transport Protocol (RTP) packet. The system, according to one embodiment, includes a sending device with an RTP packet formatter for compressing an RTP packet and generating a payload header that includes information describing the compressed RTP packet. The system also includes a payload header compressor for searching for the payload header information in a first codebook, which includes a plurality of payload headers that can be indexed. In response to the payload header information being in the first codebook, the payload header is modified by replacing the payload header information with an index code in the first codebook and, in response to the payload header information not being in the first codebook, modifying the payload header by placing a codebook transmission code in the payload header.

The receiver, in accordance with one embodiment of the present invention, receives a first Real-Time Transport Protocol (RTP) packet with an index code as part of a first payload header, indexes a codebook with payload headers that can be indexed by using the index code, and then selects one of the payload headers corresponding to the index code.

In accordance with another feature of the present invention, the receiver replaces the index code in the first payload header with the selected one of the payload headers.

In accordance with yet another feature of the present invention, the receiver receives a second RTP packet with a second payload header including a codebook transmission code and further information and reads the further information in the second payload header in response to the codebook transmission code being identified therein.

In accordance with an added feature of the present invention, the receiver sends a confirmation of receipt of the codebook back to the sending device.

In accordance with yet another added feature, the receiver receives an updated codebook and then later receives a switch code to begin using the new codebook. Upon receiving a third RTP packet with a third payload header, where the third payload header has an index code, the updated codebook is indexed by using the index code in the third payload header.

An advantage of the foregoing embodiments of the present invention is that payload header compression can be easily realized.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Embodiments of the present invention provide to a receiver an indexed codebook containing a set of possible types and orders of media frames that will potentially be received. In one embodiment, subsequent to sending the codebook, instead of including the typical Real-Time Transport Protocol (RTP) payload header, a codebook index is included in the RTP packet. Since the size of the codebook index is usually much smaller than the RTP payload header, a compression is realized through use of the present invention. The index is easily used at the receiver side to locate the proper payload header information in a copy of the codebook stored on the receiver side.

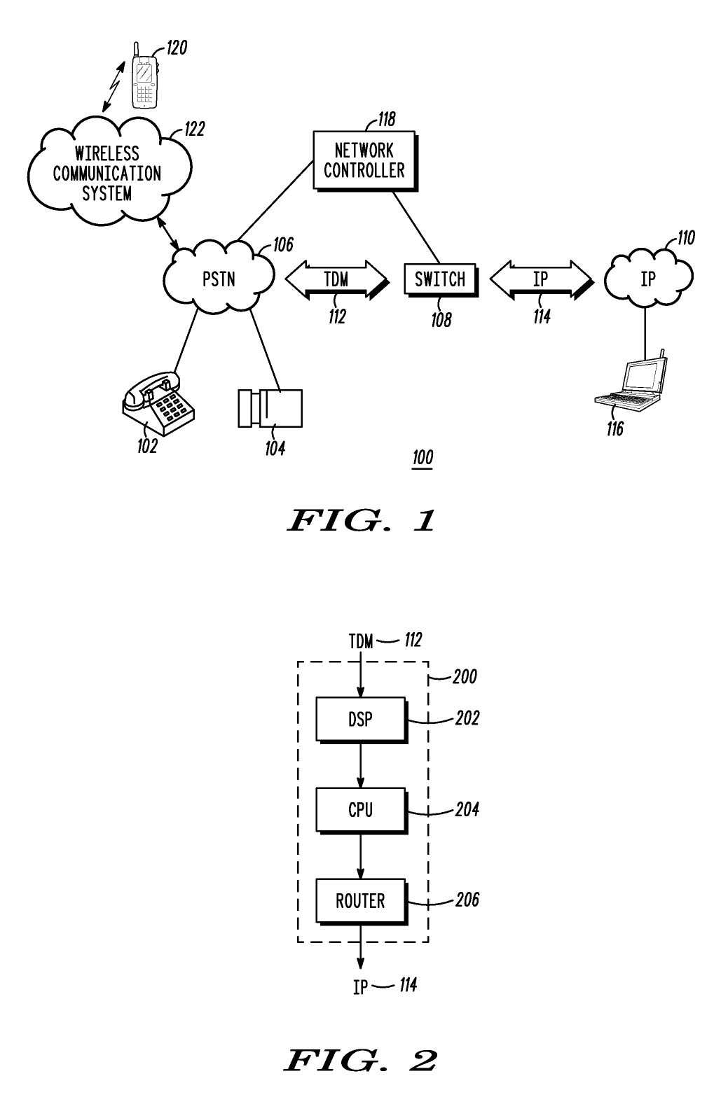

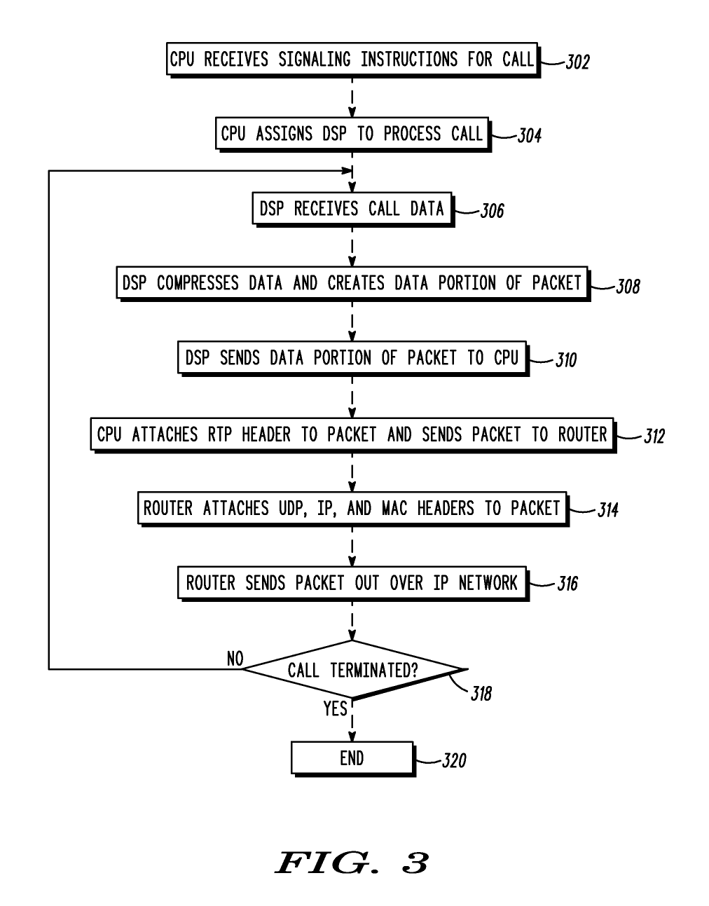

FIGS. 1-3 illustrate an exemplary communications network (FIG. 1), a packet network switch (FIG. 2), and a method of header creation (FIG. 3). Beginning with FIG. 1, a representative network 100 is illustrated. The network 100 includes phones 102 and faxes 104 that are communicably coupled to a public switched telephone network (“PSTN”) 106. Also shown in FIG. 1 is a wireless communication device 120 that communicates with and through a wireless communication system infrastructure 122 to link to the PSTN 106.

The PSTN 106 is communicably coupled to a switch 108 and an Internet Protocol (“IP”) network 110. One function of the switch is to convert time division multiplexing (“TDM”) based communications 112 to IP-based communications or “packets” 114. The switch 108 creates IP packets 114 containing destination information necessary for the packets 114 to be properly routed to their destinations, which may include computers 116 or other devices communicably coupled to the IP network 110.

A network controller 118 is communicably coupled to the PSTN 106 and the switch 108, and provides control signals to the switch 108 for proper processing of the TDM-based communications 112. The Network controller 118 can function as a Media Gateway Control (“MGC”), which converts audio signals carried on telephone circuits, such as the PSTN 106 to data packets carried over the Internet or other packet networks, such as IP network 110. As will be appreciated by those skilled in the art, the present invention is not limited to the conversion of TDM based communications to IP-based communications; instead, the present invention may be applied to any conversion of a multiplexed communication to a packet-based communication.

The internet protocol (IP) specifies the format of packets and the addressing scheme used. Many networks combine IP with a higher-level protocol such as the Transport Control Protocol (“TCP”), which establishes a virtual connection between a destination and a source. IP network 110 receives and sends messages through switch 108, ultimately to wireless communication device 120, phone 102, or fax 104. Computers 116 receive and send messages through IP network 110 in a packet-compatible format.

In FIG. 2, a block diagram of a packet network switch 200 is shown and in FIG. 3, a header creation method is shown. As can be seen in FIG. 2, the packet network switch 200 includes a digital signal processor (“DSP”) 202 communicably coupled to a CPU 204 and router 206 communicatively coupled to the CPU 204.

When converting the TDM-based communications 112 to the IP-based communications 114, the CPU 204 receives signaling instructions for the call, as shown in step 302 of FIG. 3, and assigns the DSP 202 to process the call in step 304. The DSP 202 responds by receiving the call data in step 306. The DSP 202 then compresses the data and creates a data portion of the packet in step 308. In step 310, the DSP 202 sends the data portion of the packet to the CPU 204. The CPU 204 creates a RTP header (and RTP payload header), attaches the RTP header (and RTP payload header) to the data portion of the packet and sends the packet to the router 206 in step 312. In step 314, the router 206 creates a user datagram protocol (“UDP”) header, internet protocol (“IP”) header and media access control (“MAC”) header and attaches these headers to the packet. The router 206 then sends the complete packet (data plus headers) out over the IP network in step 316. If the call is terminated, as determined in decision step 318, the process ends at step 320. If, however, the call is not terminated, the DSP 202 receives more call data in step 306 and the above-described process repeats until the call is terminated. As illustrated, both the CPU 204 and the router 206 share the responsibility for header creation in the packet network switch 200.

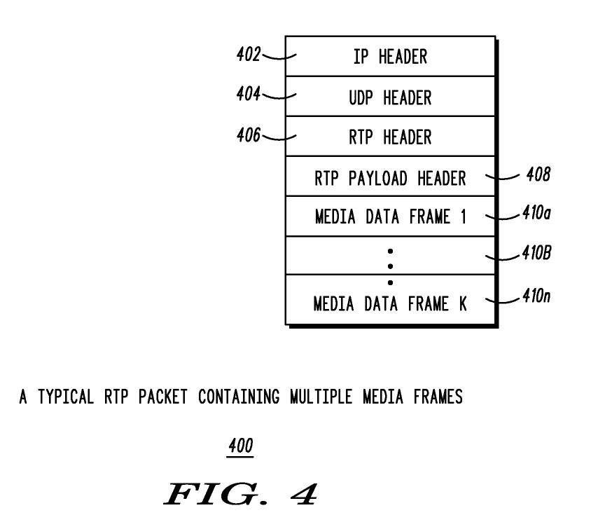

FIG. 4 illustrates a typical packet 400 containing multiple media frames 410a-410n which are the storage bins that hold the actual media information that is to be communicated. The packet 400 also includes 4 headers—an IP header 402, a UDP header 404, an RTP header 406, and an RTP payload header 408. The first three headers, 402, 404, and 406 use known header compression methods (e.g., RoHC) to reduce their size.

The payload header 408 depicts the type and order of media frames contained in the RTP packet (e.g., 1 full rate and 2 half rate frames in half/full/half order). Therefore, the payload headers between two RTP packets will always be identical if they contain the same number of media frames of the same types in the same order.

For a given RTP session, only a limited number of combinations of different types, order, and numbers of media frames will be used by the RTP sender in its outgoing RTP packets. Moreover, in many practical situations the majority of the RTP packets from the same sender will most likely use only a very small number of the possible combinations.

RTP payload headers, such as RTP payload header 408, are generally defined by the Internet Engineering Task Force (IETF) which develops and promotes Internet standards. The headers are used for bundling multiple media frames generated by most modern variable rate codecs like AMR, SMV, or EVRC before sending them over IP. The present invention, as will be discussed in detail below, compresses the RTP payload header more efficiently than any of the heretofore known methods. The inventive RTP payload header compression differs from the standard compression methods used for the RTP/UDP/IP headers 402-406 shown in FIG. 4.

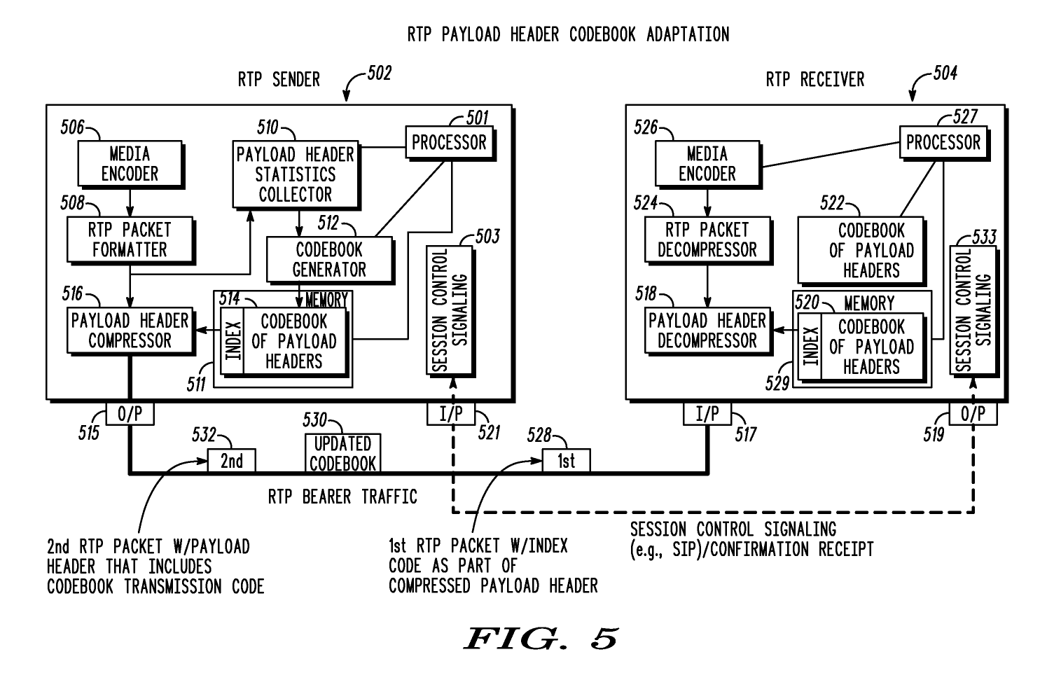

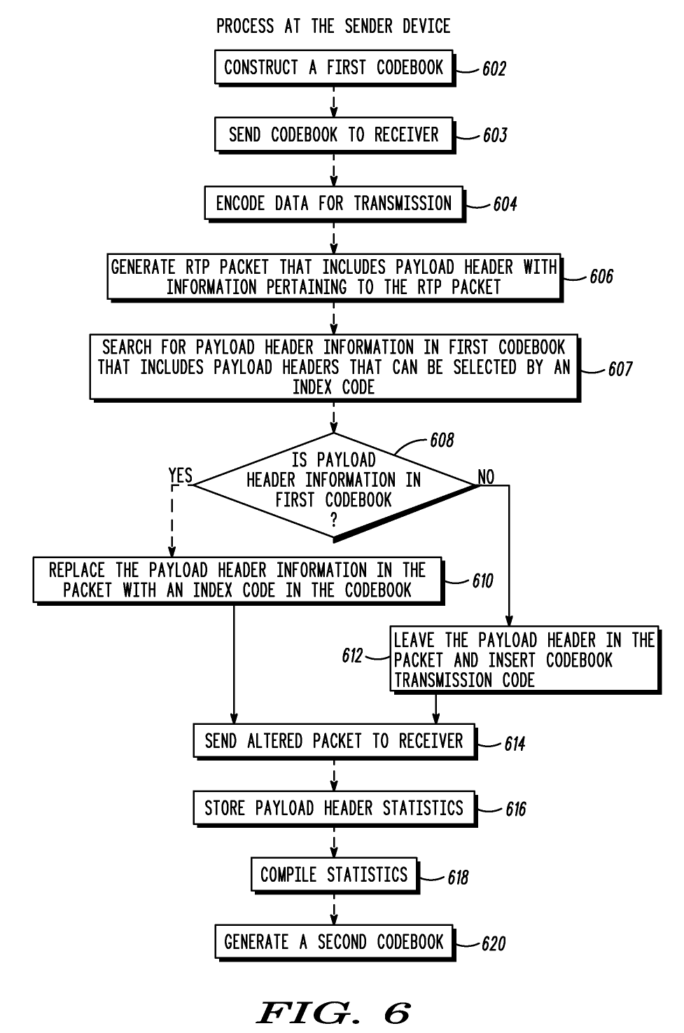

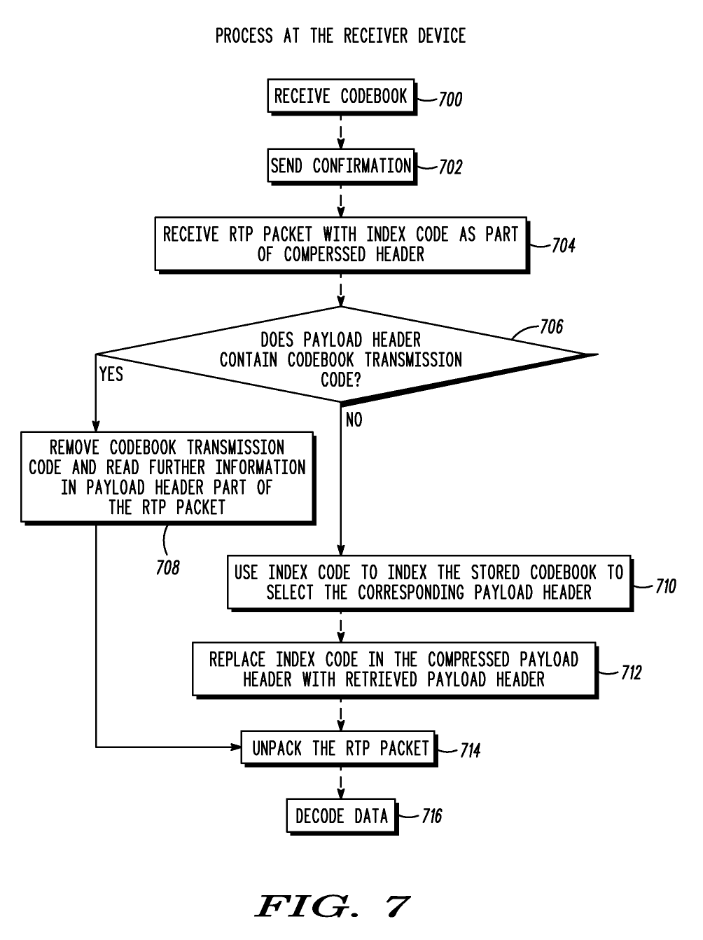

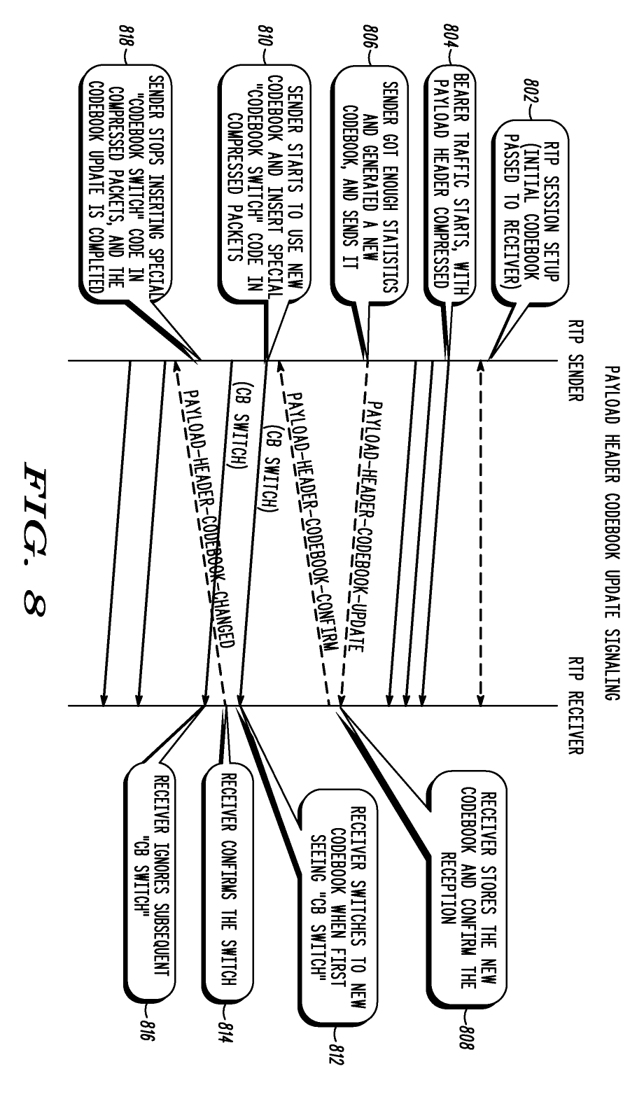

FIG. 5 is a schematic diagram of a communicatively coupled RTP sender 502 and an RTP receiver 504. FIGS. 6 and 7 are operational flow diagrams of the sender 502 and receiver 504 according to one embodiment of the present invention. More specifically, FIG. 6 shows the process that occurs on the sender side, FIG. 7 shows the process that occurs on the receiver side, and FIG. 5 shows the interrelation between the two. The steps occurring on the RTP sender 502 will first be described with reference to FIGS. 5 and 6.

Before the start of an RTP session, the RTP sender 502 identifies the subset of possible combinations that will be most frequently used for the session (this can often be derived by analyzing the Session Description Protocol (SDP) parameters of the session, from an algorithm, or from history), and in step 602, constructs a codebook 514 that contains a list of payload header variations corresponding to the subset and stores it in a memory 511. In step 603, the codebook 514 is sent, via an output 515, to the receiver 504, via an input 517, where it is stored as a receiver codebook 520. In embodiments of the present invention, passing of the codebook from the sender to the receiver is part of the call flow or can be an off-line event (e.g., sender created the codebook a priori and uses manual means to deliver and install the codebook at the receiver before the session). In other embodiments, the codebook can be part of the engineering design, created when the sender and receiver are built.

The RTP sender 502 includes a media encoder 506. A media encoder is a production tool that enables content developers to convert audio, video, and computer screen images to a media format suitable for delivery to users. The media encoder 506 receives the data to be transmitted to the receiver and encodes the data for transmission in step 604.

An RTP packet is formed in step 606 by the RTP packet formatter 508, which compresses the media data and creates a data portion of the packet. In a step 607, before sending out an RTP packet, the payload header compressor 516 will search for the payload header information in the first codebook that includes payload headers that can be selected by an index code.

If the payload header information is found (step 608), a processor 501 communicatively coupled to the memory 511 and the payload header compressor 516 will modify the payload header by replacing the payload header information with an index code in the codebook 514 corresponding to the appropriate payload header (step 610). Alternatively, in step 612, the processor 511 will cause the payload header compressor 516 to leave the payload header information in the packet and will insert a special codebook transmission code or “escape code” before it. The escape code is a signal to the receiving device 504 that there is no entry in the codebook containing the particular payload header and to not waste time searching for it. In step 614, the sender 502 will send (via output 515) the altered packet to the receiver 504.

A record, or log, is kept which identifies the type and order of media frames contained in each RTP packet (e.g., 1 full rate and 2 half rate frames in half/full/half order). Although the payload header will vary from packet to packet when the compression amounts and data types vary between them, payload headers between two RTP packets will always be identical if they contain the same number of media frames of the same types in the same order. In practice, only a limited number of combinations (of different types, order, and numbers of media frames) will be used by the RTP sender in its outgoing packets for a given RTP session. Moreover, in many practical situations the majority of the RTP packets from the same sender will most likely use only a very small number of the possible combinations.

To keep track of these combinations, in step 616, a payload header statistics collector 510 stores payload header statistics, i.e., tracks each packet formed by the RTP packet formatter 508. In step 618, the statistics are compiled by a codebook generator 512 into a record that lists each or most of the possible combinations of payload header information that is needed in a particular session to properly describe the packets.

After a sufficient number of statistics have been collected, the codebook generator 512 generates an updated codebook 530 (step 620), which is made available to the payload header compressor 516.

FIG. 7 shows the process flow steps performed at the receiver 504. In step 700, the codebook 520 is received (via input 517). In step 702, a confirmation from the session control signaling logic 533 is sent (via output 519) back to the sender 502, which receives it via input 521 and corresponding session control signaling logic 503. In step 704, an RTP packet 528 with an index code as part of the compressed header is received. Upon receipt of the compressed RTP packet, a payload header decompressor 518 checks (step 706) whether the beginning bits of the payload portion of the packet are a code book transmission code, also referred to as an “escape code”. If they are, in step 708, the receiver recovers the original RTP packet by simply removing the “escape code” from the beginning of the payload, reads further information in the payload header for interpreting the RTP packet, and continues the process with step 714. If the escape code is not present in the payload header, the payload header decompressor 518 grabs the beginning bits of the payload, which will be used as a codebook index, and in step 710 a processor 527 communicatively coupled to a memory 529 storing the codebook 520 uses the index code to select one of the payload headers in the codebook corresponding to the index code.

In step 712, the payload header decompressor 518 recovers the original RTP packet by replacing the index code in the compressed payload header with the retrieved payload header from the stored codebook 520.

Now that the payload header contains all of the necessary information for decompression, an RTP packet decompressor 524 unpacks the RTP packet in step 714. In step 716, a media decoder 526 converts the data back to a format suitable for media players.

With a small but well constructed codebook to cover the most frequently occurring payload headers in a session, the size of the indices can be far smaller than that of the actual payload headers and significant compression is achieved. The payload header compression scheme, in accordance with embodiments of the present invention, has the advantage of being: a) lossless, b) robust to RTP packet drops, c) very simple in terms of computation and implementation, d) stateless, and, e) highly effective.

Table 1 shows a first exemplary payload header in an Adaptive Multi-Rate (AMR) over RTP session compressed by the present invention. AMR is an audio data compression scheme optimized for speech coding. The RTP session description parameters are defined as follows:

m=audio 49120 RTP/AVP 97

a=rtpmap:97 AMR/8000/1

a=fmtp:97 mode-set=0,2,5,7; mode-change-period=2; mode-change-neighbor=1

a=maxptime:20

The description defines a single channel session with four rates (4.75 k, 5.90 k, 7.95 k, 12.2 k) allowed. Moreover, the Bandwidth-Efficient Mode is used and maxptime=20 means that only one media frame is allowed in each RTP packet (as described in IETF RFC 3267).

With these restrictions, the normal (i.e., uncompressed) payload header for the session is 10 bits long, as shown below:

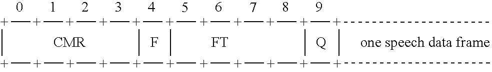

The first four bits are the codec mode request (CMR), which is for the sender of the RTP packet to request the receiver of the RTP packet to use the codec mode indicated when the receiver of the RTP sends RTP packets in the reverse direction. If no codec mode change is requested, the value of CMR is equal to 15 indicating that no mode request is present. The next bit defines what follows the frame. More specifically, if the bit is set to 1, it indicates that the frame is followed by another speech frame and if the bit is set to 0, it indicates that the frame is the last frame in the payload. The next 4 bits are the frame type (FT). For the exemplary session the FT field will take only one of 6 values (0, 2, 5, 7, 8, and 15) and FT=8 (SID) or 15 (blank) will occur only in a very small percent of packets. A quality is defined in the 9^{th} bit Q, followed by a speech data frame. For the vast majority of the packets, CMR will be 15 (no mode change request), F will be 0 (since only one media frame is allowed per packet in the session), and Q will be 1 (undamaged speech).

With the above knowledge of the session, the following exemplary codebook could be created by the RTP sender for the session:

TABLE 1

| CODEBOOK INDEX | PAYLOAD HEADER | NOTE |
|---|---|---|
| 0 0 | 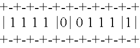 | one good 12.2 kframe, no CMR |
| 0 1 | 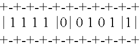 | one good 7.95 kframe, no CMR |
| 1 0 | 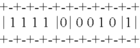 | one good 5.90 kframe, no CMR |
| 1 1 0 | 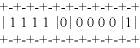 | one good 4.75 kframe, no CMR |
| 1 1 1 | (original payload header) | The Escape Code |

Given the following facts for this AMR session:

Always one frame per RTP packet due to maxptime=20;

SID frames will be few and rare since DTX (discontinuous transmission control) will remove most silence periods;

Bad quality and blank frames will be few and rare under normal conditions; and

Rate change request frames will be few and rare under normal conditions and the majority of frames will be of higher rates (12.2 k or 7.95 k) under normal conditions (session will only attempt to change to lower rates in response to a resource crunch),

We can give a very conservative assumption of a distribution of 40%, 40%, 10%, 5%, 5% for index 00, 01, 10, 110, and 111, respectively. The above illustrative codebook, with the aforementioned compression scheme, can then compress the original 10 bit payload header down to an average of 2.6 bits per packet for the session, i.e., a compression ratio of 74% is achieved. The codebook should use no more than 25 bytes to send and that can be easily passed in the session setup signaling.

### EXAMPLE 2

In a second example, the payload header in an AMR over RTP session is compressed using the present invention. The RTP session description for this second example is as follows:

m=audio 49120 RTP/AVP 99

a=rtpmap:99 AMR-WB/16000/2

a=fmtp:99 interleaving=30; mode-set=0,1,2,3,4,5,6,7

a=maxptime:20

The session description calls for a two channel session with AMR-WB rates 0-7 allowed. Moreover, octet-align payload header format will be used and maxptime=100 means that one to five media frame blocks are allowed in each RTP packet. Furthermore, interleaving=30 means that the session will use frame-block interleaving and the sender will set an interleaving group size value<30 frame-blocks. With these restrictions, the normal (i.e., uncompressed) payload header for the session will look like the following:

For packets containing 5 frame-blocks (96 bits):

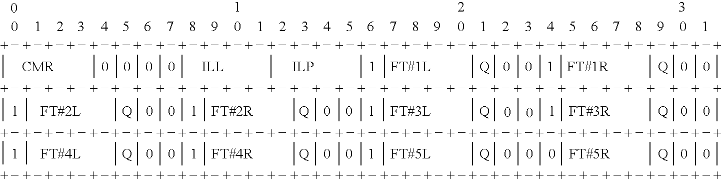

For packets containing 4 frame-blocks (80 bits):

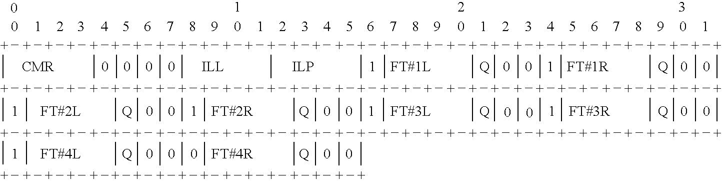

For packets containing 3 frame-blocks (64 bits):

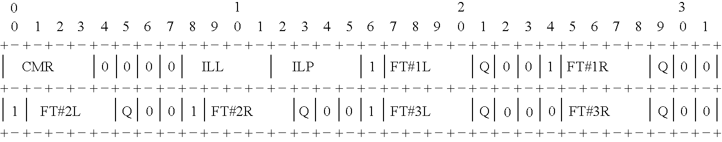

For packets containing 2 frame-blocks (48 bits):

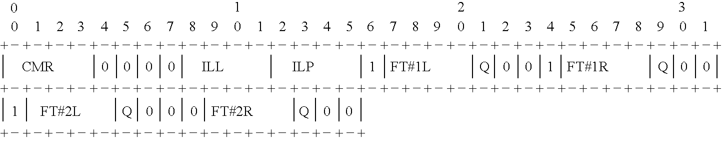

For packets containing 1 frame-blocks (32 bits):

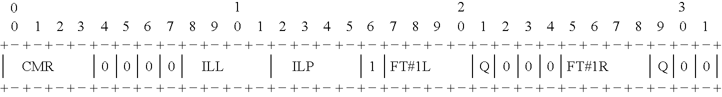

Under normal conditions, the session would have the following characteristics:

Rate change request will be few and rare, therefore CMR field will mostly be 15;

Damaged frames will be few and rare, therefore Q bits will mostly be 1's;

ILL (interleaving) will be a fixed value (below 30, in fact it must be no larger than 15) selected by the sender and won't change for the entire session;

FT fields can have a value from 0-7, 9, 14, 15;

FT fields for the same frame-block (e.g., 1 L/1 R) will always have the same value;

FT values 9 (SID), 14 (speech lost), and 15 (no data) are rare and few; Since rate changes are infrequent under normal conditions, the majority of the packets will contain frame-blocks of the same FT values.

The sender will most likely always put a fixed number (<=5) of frame-blocks in a packet as long as it can. Only the packets at the boundaries of a speech burst may contains a different number of frame-blocks.

With the above knowledge about the session (and working with the assumption that the sender has decided to use ILL=4 and 4 frame-blocks per packet), the sender can construct the following exemplary codebook.

TABLE 2
Exemplary Codebook for Example 2.

| INDEX | PAYLOAD HEADER | NOTE |
|---|---|---|
| 0xxyyywhere,xx:00-11yyy:000-111(represents32indices) | 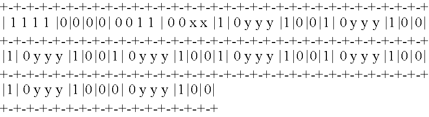 | 4 goodframe-blocks ofthe samerate yyy(0-7);ILP=xx(0-3); CMR=15 |
| 100xxyyywhere,xx:00-11yyy:000-111(represents32indices) | 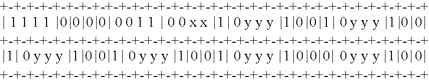 | 3 goodframe-blocks ofthe samerate yyy(0-7);ILP=xx(0-3); CMR=15 |
| 101xxyyywhere,xx:00-11yyy:000-111(represents32indices) | 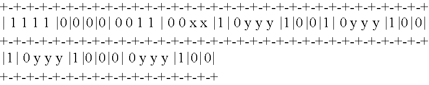 | 2 goodframe-blocks ofthe samerate yyy(0-7);ILP=xx(0-3); CMR=15 |
| 110xxyyywhere,xx:00-11yyy:000-111(represents32indices) | 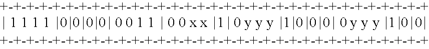 | 1 goodframe-blocks ofthe samerate yyy(0-7);ILP=xx(0-3); CMR=15 |
| 111 | (original payload header) | The Escape |
| | | Code |

Assuming a distribution of 75%, 5%, 5%, 5%, and 10% for index groups 0xxyyy, 100xxyyy, 101xxyyy, 110xxyyy, and 111, respectively, for the session (very consecutively based on the aforementioned session characteristics), the uncompressed payload header size can be estimated at around an average of 74.56 bits per packet. With the aforementioned compression scheme and the simple exemplary codebook in table 2, it can be estimated that the compressed payload header size would be averaged around 13.36 bits per packet, representing an 82% compression ratio. The exemplary codebook in table 2, with a size of about 1.1 kB if encoded in binary form, can be easily passed to the receiver during the session setup signaling.

It is not difficult to see that with a more carefully designed codebook with more entries, higher compression ratios are very reachable. It is worthwhile to note that the AMR RTP payload header format used in the above example is among the most complicated payload header formats used in the modern codecs. With a simpler payload header format from a different codec, the efficiency and simplicity of this invention could be even more evident.

Furthermore, for the template-based RTP payload header compression scheme just described, the use of a codebook that closely matches the distribution of the actual payload headers used in a given session will improve the compression ratio of the scheme. However, though the initial codebook can be based on some heuristic approach using configuration information such as session parameters or history, it is desirable to find a systematic way to automatically establish a good codebook for a given session. Therefore, embodiments of the present invention provide a method for generating a second codebook that is more narrowly tailored for a particular call session and for transmitting the second improved codebook to the receiving device. An embodiment supporting this improved codebook generation method is shown in FIG. 8.

When starting a new RTP session, the RTP sender that employs the template-based payload header compression method according to the previously-described embodiments of the present invention can first use an initial payload header codebook, which is constructed with either past payload header statistics or with some heuristic approach based on the session parameters. The RTP sender 502 sends the initial codebook 514 to the receiver in step 802. The receiver stores the initial codebook 520 and sends a response to the sender in order to confirm receipt as shown in steps 702 and 704 in FIG. 7. In step 804, bearer traffic with payload compressed headers starts flowing from the sender 502 to the receiver 504.

During the session, the RTP sender uses the payload header statistics collector 510, shown in FIG. 5, to keep a count for each different uncompressed payload header it has sent (two uncompressed payload headers are considered different if they are not of the exact length or of the same bit pattern). At some pre-set point in time (e.g., 15 sec into the session) or when the total count of all payload headers sent reaches a pre-set value (e.g., 1000), the RTP sender 502 in step 806 builds an improved codebook based on the collected payload header statistics (e.g., using some standard prefix-free code generation algorithms such as Huffman coding). In the same step, 806, the RTP sender 502 passes the new updated codebook 530 to the RTP receiver 504 via a “payload-header-codebook-update” message (e.g., an out-of-band SIP-like message). Upon receipt of the new codebook 530, the RTP receiver 504 stores (step 808) the new codebook, while continuing to use the old codebook 520 to decode the incoming RTP packets and responds with a “payload-header-codebook-confirm” message (e.g., an out-of-band SIP-like message).

It should be noted, however, that in certain embodiments of the present invention, where codebook updating is implemented and employed in an RTP session, every time the sender generates a new codebook, and before it triggers a codebook update, the sender may first check how different this new codebook is from the one being used. If the difference is determined to be insubstantial, it may choose to skip the update and continue to collect session statistics.

Upon receipt of the “payload-header-codebook-confirm” message, in step 810, the RTP sender starts compressing all subsequent outgoing RTP packets with the new codebook and inserts a special “switch-codebook” code before the compressed payload header of each outgoing packet to create a second generation RTP packet 532. Upon receipt of the first incoming compressed packet 532 with the special “switch-codebook” code, the RTP receiver, in step 812, makes a switch from the old codebook to the new codebook that it has already received in step 808. In step 814, the RTP receiver responds with a “payload-header-codebook-changed” message (e.g., an out-of-band SIP-like message).

It should be noted that in embodiments of the present invention, the new codebook sent from the sender 502, the confirmation of receipt of the new codebook, and the confirmation of switch to new codebook are not intended to be embedded in the RTP but rather are communicated in out-of-band signaling. One implementation is to add them to mid-session call signaling.

After performing the codebook switch, as executed in steps 806-814, If more packets arrives at the RTP receiver with the special “switch-codebook” code, the RTP receiver, in step 816, ignores the special “switch-codebook” code. When the RTP sender receives the “payload-header-codebook-changed” message from the RTP receiver, the sender stops inserting the special “switch-codebook” code into subsequent outgoing packets in step 818. The codebook update process is completed at this point.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A receiving device comprising:
an input adapted for receiving a first Real-Time Transport Protocol (RTP) packet with an index code as part of a compressed payload header;
a memory adapted to store a codebook of payload headers; and
a processor communicatively coupled to the input and the memory, the processor adapted to select one of the payload headers in the codebook corresponding to the index code.

2. The receiving device according to claim 1, wherein the processor is further adapted to replace the index code in the compressed payload header with the one of the payload headers which has been selected.

3. The receiving device according to claim 1, wherein the input is further adapted to receive a second RTP packet with a payload header including a codebook transmission code and further information, and wherein the processor is further adapted to read the further information in the payload header that includes the codebook transmission code in response to the codebook transmission code being identified therein.

4. The receiving device according to claim 1, further comprising an output for sending a confirmation of receipt of the codebook to a sending device.

5. The receiving device according to claim 1, wherein the input is further adapted to receive an updated codebook.

6. The receiving device according to claim 5, wherein the input is further adapted to receive a switch code and the processor is further adapted to index the updated codebook in response to recognizing the switch code.

7. A method in a receiver comprising:
receiving a first Real-Time Transport Protocol (RTP) packet with an index code as part of a compressed payload header;
indexing a codebook that comprises payload headers that can be selected by the index code; and
selecting one of the payload headers corresponding to the index code.

8. The method according to claim 7, further comprising:
replacing the index code in the compressed payload header with the one of the payload headers which has been selected.

9. The method according to claim 7, further comprising:
receiving a second RTP packet with a payload header comprising a codebook transmission code and further information; and
reading the further information in the payload header in the second RTP packet in response to the codebook transmission code being identified therein.

10. The method according to claim 7, further comprising sending a confirmation of receipt of the codebook.

11. The method according to claim 7, further comprising receiving an updated codebook.

12. The method according to claim 11, further comprising:
receiving a switch code; and
indexing the updated codebook by using the index code.

13. A sending device comprising:
a memory adapted to store a first codebook stored that includes a plurality of payload headers that can be selected by an index code;
a processor communicatively coupled to the memory, the processor adapted to:
generate a Real-Time Transport Protocol (RTP) packet that includes a payload header with information pertaining to the RTP packet;
search for the information in the first codebook; and
in response to the payload header information being in the first codebook, modify the payload header by replacing the payload header information with an index code in the first codebook; and
in response to the payload header information not being in the first codebook, modify the payload header by placing a codebook transmission code in the payload header.

14. The sending device according to claim 13, wherein the processor is further adapted to generate the first codebook prior to generating the RTP packet.

15. The sending device according to claim 14, further comprising an output adapted to send the first codebook to a receiving device.

16. The sending device according to claim 13, wherein the processor is further adapted to:
create a log of the payload header information; and
generate a second codebook, which includes a plurality of payload headers that can be selected by an index code, based at least in part on the log.

17. The sending device according to claim 16, wherein the processor is further adapted to:
search for the payload header information in the second codebook; and
in response to the payload header information being in the second codebook, modifying the payload header by replacing the payload header information with an index code in the second codebook; and
in response to the payload header information not being in the second codebook, modifying the payload header by placing a codebook transmission code in the payload header.

18. The sending device according to claim 17, further comprising:
an output adapted to:
send the second codebook to a receiving device; and
send a codebook switch instruction to the receiving device.

19. A method in a sending device, the method comprising:
generating a Real-Time Transport Protocol (RTP) packet that includes a payload header with information pertaining to the RTP packet;
searching for the payload header information in a first codebook, which includes a plurality of payload headers that can be selected by an index code; and
in response to the payload header information being in the first codebook, modifying the payload header by replacing the payload header information with an index code in the first codebook; and
in response to the payload header information not being in the first codebook, modifying the payload header by placing a codebook transmission code in the payload header.

20. The method according to claim 19, further comprising:
generating the first codebook prior to generating a RTP packet.

21. The method according to claim 19, further comprising sending the first codebook to a receiving device.

22. The method according to claim 19, wherein the codebook transmission code is placed in the payload header in addition to the payload header information.

23. The method according to claim 19, further comprising:
creating a log of the payload header information;
generating a second codebook, which includes a plurality of payload headers that can be indexed using the index code, based at least in part on the log; and
sending the second codebook to a receiving device.

24. The method according to claim 23, further comprising:
searching for the payload header information in the second codebook; and
in response to the payload header information being in the second codebook, modifying the payload header by replacing the payload header information with an index code in the second codebook; and
in response to the payload header information not being in the second codebook, modifying the payload header by placing a codebook transmission code in the payload header.

25. The method according to claim 24, further comprising sending a codebook switch instruction to the receiving device.

26. A system for compressing a payload header, the system comprising:
a sending device including:
an packet formatter for generating a payload header that includes payload header information describing a Real-Time Transport Protocol (RTP) packet; and
a payload header compressor for searching for the payload header information in a first codebook, which includes a plurality of payload headers that can be indexed;
in response to the payload header information being in the first codebook, modifying the payload header by replacing the payload header information with an index code in the first codebook; and
in response to the payload header information not being in the first codebook, modifying the payload header by placing a codebook transmission code in the payload header.

27. The system according to claim 26, further comprising, a codebook generator for generating the first codebook.

28. The system according to claim 26, further comprising, a receiving device including:
an input for receiving the first codebook and the payload header with the index code; and
a payload header decompressor for comparing the index code in the received payload header with an index code in the first codebook and replacing the index code in the payload header which has been received with a payload header in the first codebook that corresponds to the index code.

29. The sending device according to claim 26, further comprising:
a payload header statistics collector for recording information pertaining to at least two compressed RTP packets.

30. The system according to claim 29, wherein:
the codebook generator generates a second codebook based at least in part on the information which has been recorded pertaining to at least two compressed RTP packets.
